(19) United States
(12) Patent Application Publication
(10) Pub. No.: US 2022/0061298 A1
(43) Pub. Date: Mar. 3, 2022

(54) HOOF SHOE OR HOOF SHOE INSERT FOR RELIEVING THE PRESSURE ON THE TOES OF A HOOFED ANIMAL

(71) Applicants: Stephan ANDERSOHN, Gemmerich (DE); PRORAP GmbH, Lorch (DE)

(72) Inventor: Stephan ANDERSOHN, Gemmerich (DE)

(21) Appl. No.: 17/417,669

(22) PCT Filed: Jan. 17, 2020
(86) PCT No.: PCT/DE2020/100033

§ 371 Date: Jun. 23, 2021

(30) Foreign Application Priority Data
Jan. 21, 2019 (DE) 20 2019 100 308.1

(51) Int. Cl. A01L 5/00; A01L 7/02

(52) U.S. Cl. CPC A01L 5/00; A01L 7/02

(57) ABSTRACT

A hoof shoe or hoof shoe insert for a hoofed animal. An object is to relieve the pressure on the foot of a hoofed animal, in particular of a horse, on a hard ground surface. This may be achieved by a foamed plastics cushion which is arranged between the hoof of the animal and the ground surface and which is composed of a closed-cell plastics foam having a thermoplastic or elastomeric matrix with a density of between 100 and 400 all and which, at 50% compression, has a compressive stress of 150-280 kPa.

The invention relates to a hoof shoe or hoof shoe insert for relieving the pressure on the toes of a hoofed animal in accordance with the preamble of claim 1.

Hoof shoes or horseshoes are mainly used to counter-act wear and tear on the hooves of horses and other hoofed animals. This is particularly necessary for animals that are moved as working animals on paved paths and roads. Traditionally, solid materials are used for this purpose, in the case of horseshoes also metallic materials, which, owing to their material characteristics, have no or only very low cushioning behavior. Vibrations and shocks are thus transmitted via the hoof directly into the skeleton of the animal and lead to disturbances of the musculoskeletal system and muscle development.

In the case of hoof shoes, attempts have already been made to counteract this effect, which shortens the useful life of the animals, by using various rubber constructions. Since these possibilities are limited, various embodiments and designs of such soles have been developed in the prior art and will be discussed in more detail below. These solutions are very largely dependent on the material properties of the rubber compounds used.

Moreover, different inserts for hoof shoes are known. These are often likewise simple rubber mats made of relatively soft compounds or foams based on EVA or XPS. Although these briefly exhibit a desired supporting and cushioning effect, they are permanently compressed within a short time by the high compressive forces below the hooves and thus lose the required properties.

From U.S. Pat. No. 4,981,010 A a hoof shoe for horses is known, which completely surrounds the horse's hoof like a sock and is secured on the pastern by a kind of belt buckle. For the production of this hoof shoe, provision is made to take an impression of the horse's hoof in several steps, to make a mold from this in order to produce a plaster model of the horse's hoof, over which, with or without a sole, a textile sock-like hoof shoe is pulled and in turn coated with polyurethane, whereby the actual hoof shoe is produced.

In addition to complex production, it is also disadvantageous that the horse's hoof is surrounded by the sole produced in this way in a snugly fitting manner but also over the entire circumference, whereby both the sensitive areas of the horse's hoof on the back of the hoof and the anterior extensor tendon are stressed by the hoof shoe being stretched around them. Furthermore, it is not apparent how this hoof shoe individually solves the problems of the horse's hoof by adapting the sole and, in particular, how it does this reliably over a relatively long period of time. It can be assumed that an additionally inserted sole, for example, will be deformed and compressed by the horse's own weight in a relatively short time and thus the hoof-supporting function cannot be maintained.

A hoof shoe device is known from AU 2001285835 B2, which discloses an innovative intermediate layer of a porous foam material for connecting to the horse's hoof a hoof shoe that lifts the horse's hoof. Here, the foam material acts as an adhesive between the hard hoof shoe and the horse's hoof to be supported.

It is not solved here how a cushioning effect supporting the horse's hoof can be expediently achieved by this device, since the foam material is merely an intermediate layer on a solid body that forms the actual hoof shoe. In addition, it is disadvantageous that here this hoof shoe is permanently secured on the horse's hoof. It is also to be expected that here the fastening layer will soon be compressed by the weight load and deprived of its cushioning effect.

A hoof shoe that has an inserted sole is known from WO 2004/064668 A3. This is inserted into a hoof shoe, which is designed to mold itself completely to the horse's hoof. Here, fastening straps that engage both in the rear region of the hoof and in the front region of the hoof are provided, securing the hoof shoe to the horse's hoof.

In particular, the rear-engaging section of these fastening straps is considered very problematic, as this would lead to severe stress on the fetlock bend and the flexor tendon of the horse's foot. Here, the shoe is constructed from an outer sole which is of profiled design. Moreover, it is not ensured here that a sufficient cushioning effect and also a recovery of this cushioning effect is achieved by the hoof shoe and corresponding inserts.

German Laid-Open Application DE 10 2016 223 592 A1 shows a hoof shoe for a horse which is composed of a special rubber compound. Here, the disclosure is restricted primarily to the chemical composition of this rubber compound. The primary point of concern here is that of reducing hydrocarbons in this rubber compound. Here too, it is not apparent how this device on the one hand allows gentle fastening on the hoof of a horse and, on the other hand, can also exert a permanent cushioning and thus protecting effect on the hoof.

EP 2 900 058 B1 also shows a hoof shoe that can be secured on the horse's hoof. With this arrangement, the disadvantage is, in particular, that here the securing of the hoof shoe is accomplished primarily by way of the rear section of the hoof, on which a wall that rises across the entire hoof and from which struts extend to the front hoof is provided. This is therefore a solution which, as already explained, acts on the sensitive rear hoof region and exerts pressure here on the fetlock bend and the flexor tendon of the horse's leg, which is fundamentally disadvantageous. Moreover, this document does not disclose the finding of a design solution which effects permanent cushioning of the horse's hoof since an elastic element made of elastic material is merely referred to, but there is no disclosure as to how this elastic material should be designed to develop this effect.

US 2007/0039289 A1 describes a hoof shoe which has a flexible foam insert, wherein medication of the horse's hoof is to be accomplished by means of this device via a region making contact in the hoof sole, which region can be impregnated with a medicament. The specific way in which the cushioning behavior of this hoof shoe is to be achieved is unclear from this inventive approach. With this hoof shoe, it is less a matter of actual cushioning when the weight of the horse's hoof is applied and more a question of how the medicament dose applied can be applied via the flexible foam material in the interior of the hoof.

AT 010 503 U1 discloses a protection device for a hoof intended for use on cattle. Here, the protection device is molded from an elastomer and has a sole which is secured on the hoof by means of a shaft. In this case, an open-cell elastic insole is disclosed for ensuring ventilation from the shaft, for which purpose an independent ventilation line runs to this porous insole. Here too, the intention of the device is not optimum cushioning of the weight of an animal; instead, the focus here is on protecting the hoof during controlled ventilation of a protective shoe of this kind.

A hoof shoe that is supposed to be composed of ethylene vinyl acetate (EVA) is known from WO 2010/053379. The properties thereof consist above all in temperature stability and a long life and in a somewhat rubber-like property. The result is that cushioning properties do not play any role. There is also no restoring force provided with this material component since the open-cell foam acts purely as a load distributor. Moreover, it remains entirely unresolved how this cushioning material layer is to be secured on a horse's hoof or on a claw of an animal. No hoof shoe is shown, and therefore it can be assumed that this device is bonded directly to the hoof or to the claw of an animal, for example.

U.S. Pat. No. 4,212,356 discloses a hoof shoe which completely surrounds the horse's hoof and has a padded region in the central region of the hoof. This cushioning insert has a type of cushioning effect while the hoof shoe is being worn, wherein the hoof shoe itself does not exhibit any cushioning of the horse's weight in respect of the pressure on the horse's hoof since the hoof shoe itself is of rigid design. A separate additional insert is not provided. Moreover, this solution too has a problematic configuration since the hoof is completely surrounded and, particularly in the rear, sensitive region of the horse's hoof, pressure is exerted on the bulb region and the flexor tendon.

U.S. Pat. No. 6,651,410 B2 discloses a hoof shoe which can have inserts, wherein, here too, the hoof shoe per se is designed to completely surround the hoof. A large number of possible inserts are provided in the hoof shoe, and these can also be of spring-supported design, for example. In principle, it is intended by this means to allow a flexible arrangement of various inserts in this hoof shoe. Here too, however, there is no disclosure as to how, on the one hand, the cushioning can be achieved by means of a suitable material that cushions the weight of the animal and likewise has suitable restoring forces. Moreover, there is no consideration of how protective fastening of this hoof shoe on the horse's hoof can be achieved by the minimum possible imposition of fastening regions.

U.S. Pat. No. 4,564,071 shows a complex design of a hoof shoe that is held on the hoof by mechanical fastening elements, this being problematic in principle. To protect the hoof, a sock can additionally be inserted into this shoe as a cover over the hoof, wherein this additionally inserted sock is intended to absorb pressure. The inventive concept is also directed to using the sock for horse hooves of different sizes, that is to say that a standard hoof shoe can be mounted on hooves of different sizes by way of the size compensation by the sock. The abovementioned disadvantages in respect of arrangement on the horseshoe are also present here. Moreover, it remains unresolved here how the cushioning effect is achieved by the sock inserted into the hoof shoe.

Finally, US 2005 007212 likewise discloses a hoof shoe which comprises a textile hoof shoe and a cushioning insert into this hoof shoe. These inserts are likewise supposed to be manufactured from elastic material, wherein here the hoof is completely surrounded by the hoof shoe in the manner already explained above, this in particular exerting pressure on the sensitive rear side of the hoof and also not allowing air circulation around the hoof. Moreover, it also remains unresolved here how specifically a cushioning effect is supposed to be brought about by the insert in the hoof shoe. The disclosure in this publication relates here primarily to mounting on the horseshoe and gives less consideration in this context to how ideal shock absorption or an ideal cushioning effect can be achieved.

As a result, the prior art primarily discloses solutions which deal, on the one hand, with secure and firm mounting of a hoof shoe on the hoof of an animal. On the other hand, secure enclosure of the hoof should be ensured in order to avoid contamination and protect the interior of the hoof, for which purpose it is also possible to use inserts or layers.

Another desirable effect is the support of the frog in the middle of the hoof. The hoof per se is a living part of the animals and, for example, in horses, is heavily supplied with blood. In a natural lifestyle, the entire hoof is set down on the ground, including the middle part. This part then assists the blood flow in the leg with every movement. Thus, fatal circulation is often the result for a horse shod with horseshoes. On the one hand, the hooves are protected against excessive wear by the horseshoes but, on the other hand, this does not allow for optimal blood circulation. Furthermore, a situation in which the frog hangs freely in the air under no load and structures within the hoof are overloaded and destroyed is produced by the “raising” of the hoof. This can lead to a mislocalization of the hoof bones, which can promote a disease known as laminitis. In this case, there is inflammation in the hoof with local disturbances of the circulation. This frequent disease causes severe pain to the animals.

A high percentage of the horses used nowadays in actine equestrian sports can no longer be used after a period of 8 to 10 years. The most common cause are different diseases of the hooves and joints. Since the training of these animals is a significant cost factor, combating these diseases, apart from the primary aim of animal welfare, is also relevant in terms of economics.

Diseases associated with this are, for example,
arthritis
osteoarthritis
joint problems of many different kinds,
podotrochlosis,
leather dermatitis of the hooves,
back problems for the horse or
problems with converting the hooves from iron to bare hooves.

It is the object of the present invention, given this background, to design a hoof shoe and a hoof shoe insert in such a way that improved relief of the pressure on the hoof and, in particular, on the hoof frog is achieved. At the same time, the shoe should be secured on the hoof of the animal in such a way that special protection of the hoof bulb as well as the anterior extensor tendon can be achieved.

This is achieved by a hoof shoe and a hoof shoe insert according to the characterizing features of claim 1.

The further claims relate to advantageous designs of the invention.

The inventive solution provides a hoof shoe or hoof shoe insert having at least one foamed plastics cushion for relieving pressure arranged between the foot of a hoofed animal and the underlying surface. According to the invention, this plastics cushion is composed of a closed-cell plastics foam, wherein the matrix used can be of thermoplastic or elastomeric design and has a density in a range between 100 and 400 g/l. According to the invention, this plastics cushion has a compressive stress of 150 to 280 kPa at 50 percent compression.

By means of this combination of features, it is ensured that the foamed plastics cushion unites in itself features which are advantageous particularly for supporting the hooves of an animal. The flexible foamed plastics cushion is greatly compressed in its edge regions by the encircling hoof wall and, at the same time, owing to the plastics matrix of closed-cell design, is pressed into the sole region of the animal's hoof.

The plastics cushion, which yields into the arch of the sole, thus increases the cushioning supporting pressure in the horse's hoof on the sensitive regions, especially on the hoof frog. In this way, owing to the compressive stress created in accordance with the invention, the plastics cushion has the effect that there is a displacement of material into the arch of the sole when the hoof of the animal treads on the hoof shoe or the hoof shoe insert, and thus the support of the hoof bulb as well as the hoof frog can take place in accordance with the invention.

According to the invention, it has proven particularly advantageous to use a closed-cell plastics foam in the form of a particle foam with bead sizes of 1.5 mm to 10 mm for this plastics cushion. The particle foam of such a composition, consisting of the matrix described above, is particularly suitable for supporting the desired deformation process and thus for supporting the sensitive regions of the hoof bulb and the hoof frog. Thus, the immediate pressure of the underlying surface on these regions of the animal's hoof is strongly cushioned.

In particular, the sudden occurrence of pressure is avoided since the design of the cushioning supporting pressure on the inner hoof first increases as a result of the compression of the plastics cushion up to the full weight load of the occurring animal's hoof and then decreases again after it has been relieved by the recovery of the plastics foam. That is to say, the effect lies on the one hand in the cushioning supporting pressure itself, and in addition in the way in which this pressure is built up and released progressively rather than abruptly.

Furthermore, it is a significant feature of the plastics matrix used and its combination of density and compressive stress that a spontaneous and thus short-term recovery of the material from a 50 percent compression is ensured at least in a region of about 95% of the initial thickness. This is essential to ensure that the desired effect of deformation and the resulting cushioning are permanently guaranteed and thus that the interaction of compression and decompression of the hoof shoe or the hoof shoe insert resulting from a step sequence leads repeatedly in a constant alternation to the desired cushioning and support effect on the hoof.

For the purposes of the present invention, spontaneous means a recovery within 2 minutes in a normal usage case.

However, it should also be pointed out in this context that there is a certain effect of use. The plastics cushions should ideally be used in daily rotation with a second set of plastics cushions for long-term maintenance of the positive recovery properties. With this measure, spontaneous recovery in 2 minutes is obtained. Should a user use the soles over a longer period of time without the “intermediate relaxation” achieved by alternating use, the material will behave significantly more sluggishly.

The special design of the hoof shoe insert or hoof shoe according to the invention also has the advantage that, in addition to the aforementioned spontaneous recovery, a complete recovery to a decompressed starting height of the plastics cushion after 50 percent compression is achieved in a period of 30 to 75 minutes. That is to say that the recovery of the plastics cushion and thus of the cushioning effect to its initial situation, which has not been achieved hitherto in the prior art, is an essential aspect here for the long-term use of the hoof shoe and the hoof shoe insert in the sense of the invention.

According to the invention, the modulus of elasticity at a mean ambient temperature of 20° C. is also at a low value of 1 to 100 MPa, which is conducive to deformability and deformed penetration into the inner hoof area. It has been found here that a value between 15 and 25 MPa, in particular, achieves very good results.

In an advantageous embodiment of the invention, in order to assist the effect on the hoof bulb and the hoof frog, provision can also be made for the inner surface of the hoof shoe or the hoof shoe insert not to be designed as a flat surface, but for an elevation to be provided here in the regions which are to receive supportive reinforcement, in particular. That is to say that in and in particular here in the region of the hoof frog, a raised cushion can be provided, which then has an additional supporting effect due to the deformation in the central region that occurs during compression.

Another positive effect of the deformability and the adaptation to the inner hoof is that the hoof shoe or the hoof shoe insert is fixed to the horse's hoof against unintentional rotation. The high elasticity means that the hoof shoe or hoof shoe insert presses strongly against the course of the hoof wall and the arch of the sole of the hoof during compression, thus reliably preventing rotation at the hoof.

In a practical design of the hoof shoe or hoof shoe insert, this is modeled on the outer contour of the horse's hoof, but has a larger surface area than the horse's hoof, as a result of which, in the event of compression due to loading by the horse's hoof, the hoof walls penetrate into the plastics cushion, whereby, on the one hand, the described effect of supporting the hoof sole of the hoof of the animal takes place, but, on the other hand, a rim surrounding the hoof wall in the outer area is also of annular design. This also ensures a secure hold of the hoof shoe or the hoof shoe insert on the hoof of an animal.

In a particularly advantageous design, it is envisaged that a rim region on the plastics cushion that surrounds the hoof wall at least in some section or sections is formed. That is to say that an annular rim extends approximately vertically on the plastics cushion, enclosing the hoof wall in a shaft-like manner and thus already providing a basic hold of the hoof shoe or hoof shoe insert on the animal's hoof.

Here, in particular, in an advantageous design, it is envisaged that this encircling rim on the hoof shoe or the hoof shoe insert already extends in such a way as to follow in its slope the design of the animal's hoof. In addition, it is envisaged according to the invention that the slopes along this annular rim vary between the front rim formation in the region of the front side of the animal's hoof and in the rear region of the animal's hoof.

Moreover, it is envisaged that the shaft formed by the annular rim on the plastics cushion tapers towards the upper opening thereof. The thickness of the annular wall is thus not constant from the plastics cushion toward its upper opening, but rather the thickness of the wall widens toward the upper opening of the shaft, which additionally promotes an initial securing of the hoof shoe or hoof shoe insert on the animal's hoof since the hoof slides into this widening in the lower region of the shaft when the hoof shoe is put on, whereas the upper region fits more closely to the hoof. Owing to the elasticity of the material, a good initial basic stability of the fastening is thus already achieved when the hoof shoe is slipped over the animal's hoof.

In addition, it is envisaged according to the invention that fastening means are arranged on the plastics cushion of the hoof shoe, which span this animal's hoof in order to secure it to the animal's hoof. According to the invention, it is envisaged here that this fastening means extends in a strap-type manner from the rear region of the hoof shoe over the pastern of the animal's hoof, whereby it is achieved that the sensitive rear region of the animal's hoof is not compressed and thus irritated by a fastening means.

By combining the shaping of the shaft with this fastening, the design effort required for this can thus be reduced to a minimum, in order to reduce precisely the stress that usually occurs on the animal's hoof as a result of a closed hoof shoe. Here, the closure of the fastening means can be effected by the elasticity of the fastening means itself, but mechanical closures, for example buckles, touch-and-close fasteners or the like, can also be used.

A particularly advantageous design of the strap-like fastening means envisages here that padding elements are arranged on the inside of the fastening means in such a way that in the front region of the fastening means, which spans the front pastern of the animal's foot, no pressure load is created on the animal's foot. That is to say that a free space with reduced compression is created here in a region where the extensor tendon on the animal's foot is responsible for the movement of the animal's hoof.

It is this extensor tendon that is usually stressed by hoof shoes that are secured on the animal's hoof in such a way as to surround it fully, contributing to tendon irritation and painful inflammation. Owing to the arrangement of the partial internal padding on the strap-like fastening means, it can be precisely determined in which regions the pressure of the fastening on the animal's foot takes place and in which region relief is possible. In this way, tendon irritations can be consciously avoided.

In an advantageous further development of the invention, the production process of the hoof shoe inserts moreover permits the integration of sensor elements. Pressure-sensitive embodiments of these sensors in particular are useful and well-suited for checking the progress of therapy.

The measured values recorded by these sensors enable an evaluation, for example, in the form of a 2-dimensional image of the pressure exerted on the hoof shoe insert or hoof shoe and thus, conversely, of the load on the hoof in the hoof shoe. The improvement of hoof symmetry and thus of the statics of the musculoskeletal system which are aimed at in the course of therapy results in a changed introduction of force and distribution of pressure on the hoof shoe insert or the hoof shoe and thus directly on the hoof, which can be determined, traced and documented by means of these continuous measurements. This possibility of monitoring the load on the hoof should be used during the course of therapy and for adjusting the required training.

It is advantageous here to transmit the data via electronic wireless-communication components that are also integrated and connected to the sensors to a suitable end user device, e.g. a tablet, and to subject them to further processing. Alternatively, it also possible to integrate an electronic memory component, e.g. a memory chip, which enables a later readout of the measured values recorded by the sensors. This can also be done wirelessly or by means of suitable interfaces arranged on or in the hoof shoe insert or the hoof shoe.

In summary, the insert for a hoof shoe or the hoof shoe according to the invention is characterized by the following primary characteristics:
use of an expanded thermoplastic polyurethane or thermoplastic polyacrylic or polyolefin, in particular in the form of a particle foam,
low modulus of elasticity of the raw material and thus a soft material,
very high toughness,
very high restoring force,
approximately complete recovery over a defined time period from compression undergone,
support of the frog to avoid common diseases of hoofed animals,
no leakage of gel or stabilizing fluid,
inhibition of rotation of hoof shoes on the hoof,
possibility of creating 3D geometries, especially for additional support of the frog as a therapeutic insert,
high chemical resistance to media commonly used in animal husbandry,
promotion of blood circulation in the hoof due to non-rigid pressure surface,
possibility of coloring the insert,
possibility of holding the insert on the hoof by prefixing, optionally without additional retention straps or buckles,
by virtue of the cushioning, also protection of the rider from shrinkages caused by horseshoes and other high-modulus materials,
protection from osteoarthritis in the joint apparatus of the animals.

An embodiment of the invention is described in greater detail below with reference to drawings.

In the drawings:

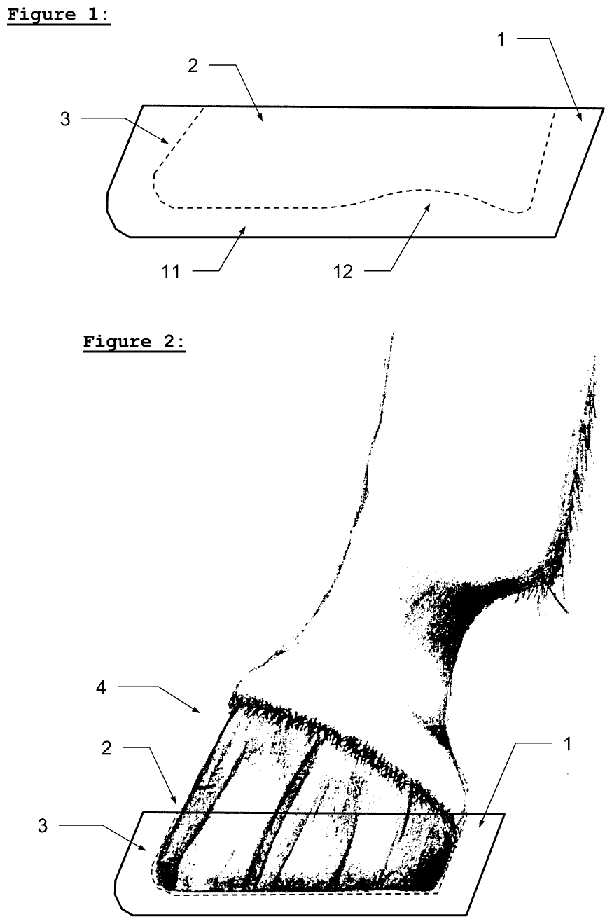

FIG. 1 shows the device according to the invention in an embodiment as a hoof shoe without fastening straps 5, 6;

FIG. 2 shows an animal's hoof 4 in the hoof shoe according to the invention;

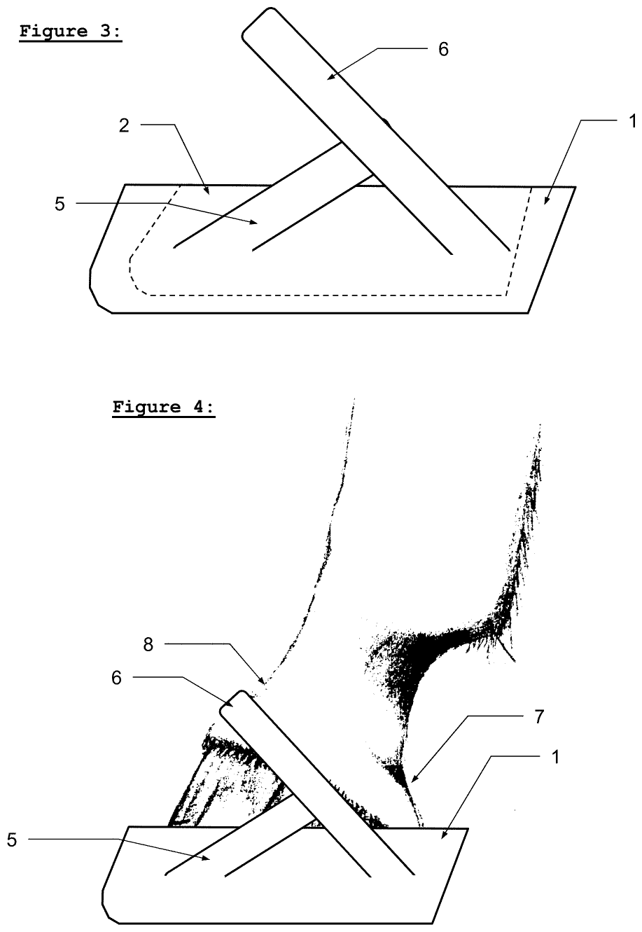

FIG. 3 shows the hoof shoe according to the invention with fastening means 5, 6 arranged thereon;

FIG. 4 shows an animal's hoof 4 with a hoof which is set in the hoof shoe and is secured on the animal's hoof 4 by means of fastening straps 5, 6, and

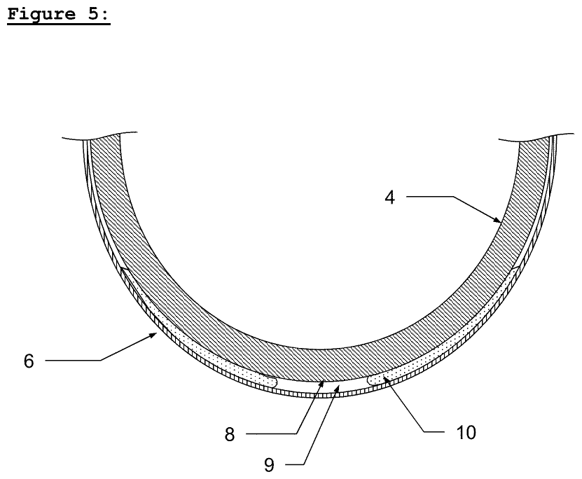

FIG. 5 shows a simplified sectioned view of a fastening strap 6 resting against an animal's hoof 4 with pads 10.

In the present drawings, a version of the invention in the form of a hoof shoe is illustrated in a simplified representation, the hoof shoe being constructed on the basis of a plastics cushion 1 in accordance with the features indicated in the claims. Here, FIGS. 1 and 3 each show a hoof shoe, wherein this shoe is illustrated without fastening means 5 and 6 in FIG. 1 and with fastening means 5 and 6 in FIG. 3. In both figures, it can be seen that the hoof shoe is of one-piece design, such that it is formed so as to partially surround the hoof, wherein the hoof shoe has an encircling rim 3 which starts from a base plate 11 and surrounds an interior space 2 as a shaft.

In this case, in this version, this rim 3 forming the shaft is not formed with a continuously uniform material thickness but is designed to widen toward the opening of the hoof shoe. This is a targeted measure aimed at ensuring that the hoof shoe can be slipped over the animal's hoof 4 by virtue of the elasticity of the plastics cushion 1. At the same time, the widening of the material thickness of the rim 3 toward the upper opening on the one hand shapes the inner space 2 to follow the conical shape of the hoof, and on the other hand this widening also provides what is already a first stabilizing element for a secure hold on the horse's hoof.

That is to say that the widening of the rim toward the upper open region of the hoof shoe has the effect that the material is expanded here when the hoof is inserted and is compressed by the inserted hoof, and thus the hoof is prevented from sliding out of the hoof shoe according to the invention.

FIG. 2 now also shows an animal's hoof 4 inserted into this first hoof shoe. Here it can be seen that the hoof has been inserted into the opening 2 in the hoof shoe 1 and the encircling rim 3 protrudes approximately halfway over the hoof in this illustration and thus already provides the hoof shoe with basic stability when secured on the hoof.

It should be noted here that both the material thicknesses of the illustrated hoof shoe in relation to the size representation of the hoof are merely exemplary and are in no way to be considered as determining or restricting the invention. In particular, the thickness of the base plate 11 of the plastics cushion 1 forming the hoof shoe 1 can also be designed to be considerably thicker and is determined here in dependence on the weight of the animal to be supported by the hoof shoe.

FIG. 3 now shows fastening means 5 and 6, which in this case are of strap-type design and are arranged on the outside of the hoof shoe. This is merely an exemplary arrangement since, for example, these fastening means 5, 6 can also extend around the hoof shoe or only at its upper edge.

What is relevant here, however, is that these fastening means are arranged to engage the animal's foot to a small extent. In the illustrated design, strap-type fastening means 5 and 6 are located in combination here since the actual strap-type fastening means 6 which spans the animal's foot is braced to the front region of the hoof shoe by fastening means 5 extending transversely thereto, so as to ensure uniform pressure of the hoof shoe against the animal's hoof and to mutually stabilize the fastening means 5 and 6.

The view of the mounting of the hoof shoe on the animal's foot in FIG. 4 makes clear here that the flexor tendon 7 extending on the animal's foot on the rear side of the hoof is completely excepted from the fastening of the hoof shoe. This is very advantageous since in this way irritation of this tendon, during the tilting movement of the animal's foot, by the fastening means 5 or 6 that may possibly span said tendon can be reliably excluded.

All that is spanned is the pastern in the front region of the leg, wherein, here too, irritation of the extensor tendon 8 extending here is avoided according to the invention, this being explained in greater detail in the following FIG. 5.

FIG. 5 again shows the strap-type fastening means 6 spanning the pastern of the animal's leg, wherein it can be seen here that, in an advantageous design of the invention, padding elements 10 are provided on the inside of the strap-type fastening means 6, said elements starting from the hoof and extending approximately to the pastern. The aim of these additional padding elements 10 is, on the one hand, the actual padding itself and thus gentler contact with the pastern. Moreover, however, the effect according to the invention is that this padding also creates a spacing between the strap-type fastening means 6 and the animal's hoof 4 in the region of the extensor tendon 8 on the front side of the animal's leg. The free space 9 shown schematically here is created by the fact that the padding elements 10 on both sides are only arranged up to a region on the strap-type fastening means 6 that adjoins the course of the extensor tendon 8 on the pastern, and leave a gap free here. That is to say that the region in which the extensor tendon spans the pastern approximately vertically is excluded by these padding elements, with the result that a region is created here in which there is less or no pressure of the strap-type fastening means 6 on the pastern of the animal.

Basically, it should be noted once again that these are exemplary embodiments in simplified representation and thus the dimensions for the invention are only to be understood as exemplary.

1. A hoof shoe or hoof shoe insert for relieving the pressure on the foot of a hoofed animal on a hard underlying surface, at least comprising a foamed plastics cushion, which is arranged between the hoof of the animal and the underlying surface, wherein
the plastics cushion is formed of a closed-cell plastics foam having a thermoplastic or elastomeric matrix of a density between 100 and 400 g/l,
wherein the plastics cushion has a compressive stress of 150-280 kPa at 50% compression.

2. The hoof shoe or hoof shoe insert as claimed in claim 1, wherein
the closed-cell plastics foam is in the form of particle foam with bead sizes of 1.5 mm to 10 mm.

3. The hoof shoe or hoof shoe insert as claimed in claim 1, wherein
the plastics cushion is designed to be multicompressible and has a spontaneous recovery from a 50% compression to at least 95% of the initial thickness.

4. The hoof shoe or hoof shoe insert as claimed in claim 1, wherein
the plastics cushion achieves a return to a relaxed, approximately full initial thickness from a 50% compression after 30 to 75 minutes.

5. The hoof shoe or hoof shoe insert as claimed in claim 1, wherein
the plastics cushion consists of an expanded thermoplastic polyurethane, polyacrylic or polyolefin.

6. The hoof shoe or hoof shoe insert as claimed in claim 1, wherein
the material of the plastics cushion has a low modulus of elasticity of 1 to 100 MPa at 20° C.

7. The hoof shoe or hoof shoe insert as claimed in claim 1, wherein
the plastics cushion is designed to be raised in the central region to provide increased support for the frog in the animal's hoof.

8. The hoof shoe or hoof shoe insert as claimed in claim 7, wherein
the elevation in the central region of the plastics cushion is designed to inhibit rotation by molding itself into the hoof.

9. The hoof shoe or hoof shoe insert as claimed in claim 1, wherein
the plastics cushion is designed with its outer contour following the hoof but to be larger than the hoof surface,
as a result of which, when the plastics cushion is compressed, a raised annular rim surrounding the hoof at its outer edge is formed.

10. The hoof shoe or hoof shoe insert as claimed in claim 1, wherein
the plastics cushion has a raised annular rim surrounding the hoof at least in some section or sections at the hoof wall thereof.

11. The hoof shoe or hoof shoe insert as claimed in claim 10, wherein
the rim of the plastics cushion surrounding the hoof wall is inclined at least in some section or sections toward the inner space surrounded by the rim, and the wall thickness of the rim widens at least partially starting from the base plate,
as a result of which a shaft formed by the annular rim tapers toward the upper receiving opening thereof.

12. The hoof shoe or hoof shoe insert as claimed in claim 11, wherein
this taper is steeper at the front side of the hoof shoe, and the rim thus slopes more steeply inward in this front section.

13. The hoof shoe or hoof shoe insert as claimed in claim 1, wherein
fastening means for releasable fastening on the animal's hoof are arranged on the plastics cushion.

14. The hoof shoe or hoof shoe insert as claimed in claim 13, wherein
the fastening means are arranged so as to span the front region of the hoof or the pastern, starting from the rear region of the plastics cushion,
wherein the rear side of the hoof remains free from fastening means.

15. The hoof shoe or hoof shoe insert as claimed in claim 13, wherein
at least one touch and close fastener is arranged on the plastics cushion as a fastening means for releasable fastening on the horse's hoof

16. The hoof shoe or hoof shoe insert as claimed in claim 13, wherein
padding elements are arranged in such a way on the inside of the fastening means spanning the animal's hoof that a compression-reduced free space remains above the extensor tendon on the animal's hoof.

17. The hoof shoe or hoof shoe insert as claimed in claim 1, wherein
the plastics cushion is arranged in a hoof shoe comprising fastening means for releasable fastening on the animal's hoof.

18. The hoof shoe or hoof shoe insert as claimed in claim 1, wherein
at least pressure-sensitive sensor elements are arranged on or in the plastics cushion to detect the introduction of force and distribution of pressure through and on the hoof.

19. The hoof shoe or hoof shoe insert as claimed in claim 18, wherein
electronic components for wireless communication and evaluation of the measured values of the force introduction and pressure distribution detected by the pressure-sensitive sensor elements are arranged on or in the plastics cushion and connected to the sensor elements.
